(19) United States
(12) Patent Application Publication
(10) Pub. No.: US 2007/0022139 A1
(43) Pub. Date: Jan. 25, 2007

(54) Novelty system and method that recognizes and responds to an audible song melody

(76) Inventor: Bradley C. Stewart, Chandler, AZ (US)

Correspondence Address: LAMORTE & ASSOCIATES P.C., P.O. BOX 434, YARDLEY, PA, 19067, US

(21) Appl. No.: 11/188,269

(22) Filed: Jul. 25, 2005

(51) Int. Cl. G06F 17/00

(52) U.S. Cl. 707/104.1

(57) ABSTRACT

A system and method of retrieving a musical recording from a database that contains a plurality of music recordings. Each of the musical recordings in the database has a unique musical tune or melody. Within the database, each of the plurality of musical recordings is identified by a numerical code derived from the tune of that musical recording. The system detects an audible musical tune that is being sung. A numerical code is derived for the audible musical tune that is detected. The numerical code corresponding to the audible musical tune is compared with the numerical codes for the plurality of recordings until at least a partial match is found. Once a match is found, a selected musical recording is retrieved from the database and is played.

### BACKGROUND OF THE INVENTION

1. Field of the Invention

The present invention relates to electronic systems that can detect and identify a specific sequence of audio signals. The present invention also relates to novelty devices that contain interactive programming that is activated by audio signals.

2. Prior Art Description

Dolls and other toy figures have been a favorite play toy of children for hundreds of years. However, it has only been in the latter part of the past century that dolls and toy figures have been made with audio components that enable such toys to simulate speech. Today, a great many dolls and toy figures are commercially available that talk, or produce other audible sounds when activated. There are dolls that speak simple words and phrases when a string on the doll is pulled. There are many dolls with electronic voices that speak when the doll is squeezed in a certain area. Still other dolls exist that have sound sensors that detect ambient noise. The doll activates when a certain sound intensity is reached. Thus, the toy will activate if a person claps or makes another sudden loud noise.

In all such prior art dolls, the audio response of the doll is purposely activated by a person, such as a child, who desires to hear the audio response. The child therefore anticipates the response. Once the audio response is activated, the audio response is often predictable. That is, the child playing with the doll usually knows the sound or phrase the doll will produce.

The present invention improves upon this technology by analyzing the sounds made by a child playing with the doll and selecting an audio response that depends upon those detected sounds. In this manner, the doll becomes an interactive device that responds to a child depending upon the input of the child. This invention is described and claimed below.

### SUMMARY OF THE INVENTION

The present invention is a system and method of retrieving a musical recording from a database. A database is provided that contains a plurality of music recordings. Each of the musical recordings in the database has a unique musical tune or melody. Within the database, each of the plurality of musical recordings is identified by a numerical code derived from the tune of that musical recording.

The system detects an audible musical tune that is being sung, hummed or played by a person near the system. A numerical code is derived for the audible musical tune that is detected. The numerical code corresponding to the audible musical tune is compared with the numerical codes for the plurality of recordings until at least a partial match is found. Once a match is found, a selected musical recording is retrieved from the database and is played.

The system, therefore, has the ability to listen for a song being sung, wherein the system identifies the song, retrieves that song from a database and begins to play the song.

### BRIEF DESCRIPTION OF THE DRAWINGS

For a better understanding of the present invention, reference is made to the following description of an exemplary embodiment thereof, considered in conjunction with the accompanying drawings, in which:

FIG. 1 is a perspective view of an exemplary embodiment of the present invention.

FIG. 2 is a schematic showing the components of the present invention; and

FIG. 3 is a block diagram showing the methodology of the present invention.

### DETAILED DESCRIPTION OF THE DRAWINGS

Although the present invention system can be incorporated into many objects, such as a talking mirror or a talking crystal ball, the present invention system is particularly well suited for use in a toy character, such as a doll. Accordingly, by way of example, the present invention is illustrated as being embodied in a toy character in order to set forth the best mode contemplated for the invention.

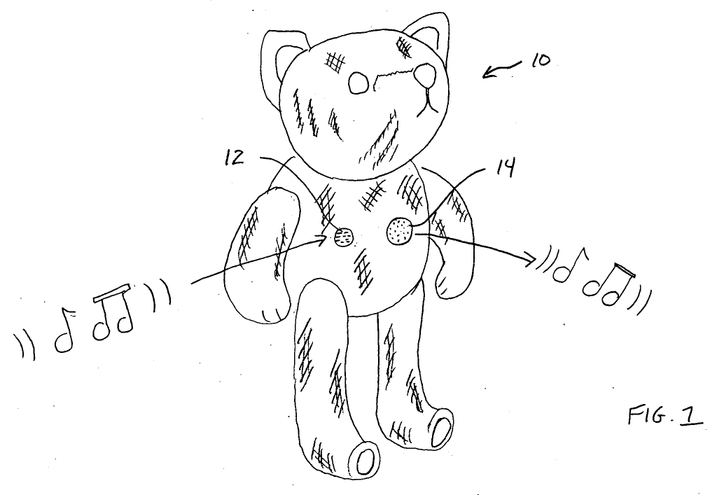

Referring to FIG. 1, there is shown a toy figure 10 that embodies the present invention system. In the shown embodiment, the toy figure 10 is a teddy bear. However, such a toy figure is merely exemplary of any toy figure and should be considered a matter of design choice.

A microphone 12 is present on the toy figure 10 that can detect sound. The toy figure 10 also includes a speaker 14 that can broadcast sound. Once activated, the microphone 12 detects if a person near the toy figure 10 is singing, humming or otherwise creating a musical melody. If a song melody is detected, the actual song melody being used is electronically recognized. The toy figure 10 will then automatically join in the singing by broadcasting the exact song that is being sung by the person. The toy figure 10, therefore, appears to understand the song that a person is singing and joins in the singing of that song.

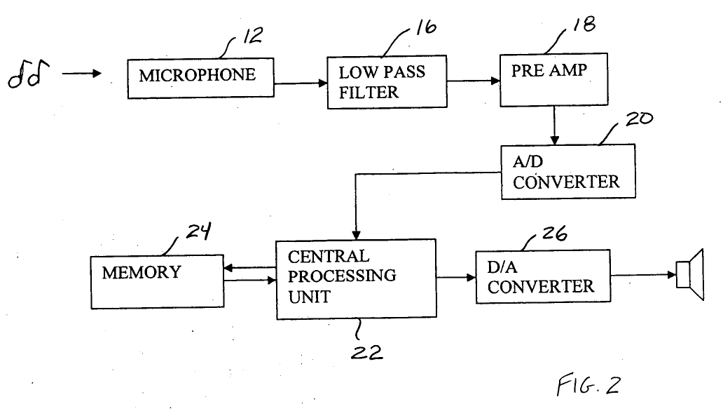

Referring to FIG. 2, it can be seen that the present invention system receives the sound signals of a person singing, via a microphone 12. The human voice has a typical range in pitch of between 50 Hz and 600 Hz. Consequently, the microphone 12 selected preferably has a low signal-to-noise ratio in this frequency range. The microphone 12 receives an audio signal and converts those sound signals into corresponding electronic analog signals. The analog signals are filtered by a low pass filter 16 to help eliminate background noise. The low pass filter 16 preferably has sufficient bandwidth to pass the fundamental pitch components of human speech with enough filtering of upper end frequencies so that Nyquist sampling restrictions are met.

The filtered analog signal is passed through a preamplifier 18. The preamplifier 18 preferably employs an automatic gain control circuit to prevent distortion of the input signal from the microphone 12 is over-driven.

The filtered and amplified analog signal is converted into a corresponding digital signal by an analog-to-digital (A/D) converter 20. The A/D converter 20 preferably has at least eight bits of resolution.

The incoming digital signal is directed to a central processing unit 22. The central processing unit 22 analyzes the incoming signal in a manner that is later described. The central processing unit 22 is also coupled to a memory 24. Two data collections are stored in the memory 24. In a first data collection, a library of song identification patterns is stored. In a second data collection, recordings of songs that are identified by the song identification patterns are stored. As will later be explained, the central processing unit 22 receives the incoming digital signals and converts those signals into an active song identification pattern. The active song identification pattern is then compared to the stored song identification patterns in the memory 24. If a match is found between the active song identification pattern and a stored song identification pattern, the song recording associated with the stored song identification pattern is downloaded from the memory 24. The data of the song is then converted into an analog signal by a digital-to-analog (D/A) converter 26. The analog signal is then broadcast aloud through a speaker 14. The song broadcast by the toy figure 10 (FIG. 1) therefore matches the song detected by the microphone 12 and the toy figure appears to have heard the song being played and decided to join in the singing of the song.

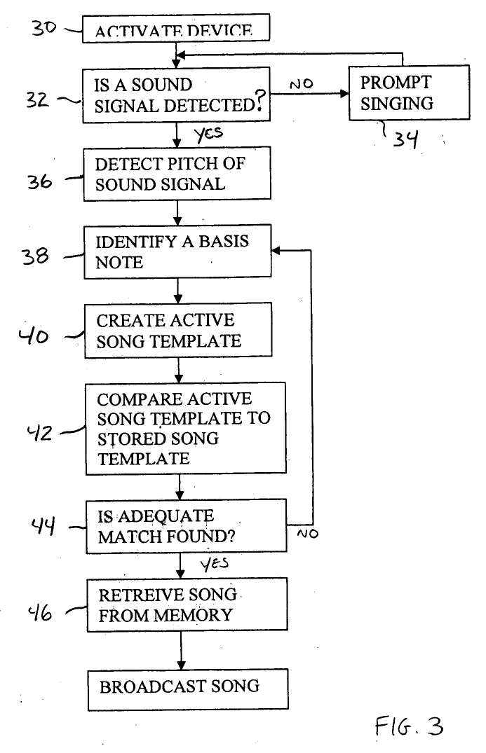

Referring to FIG. 3, the method of operation for the present invention system can be explained. As is indicated by Block 30, the system is initially activated by a user. This can be done with a simple on/off switch located somewhere on, or under, the toy figure. Once activated, the system detects audible sound signals. See Block 32. Audible sound signals are then analyzed to see if the audible sound signals are those of a person singing. This can be done by detecting any rhythmic pattern in the audible sound signals being detected. If audible sound signals are random, it can be assumed that the detected audible sound signals are noise or a person talking in prose. However, if the incoming sound signals fluctuate in a recognizable pattern, it can be assumed that the microphone is detecting a song melody.

If no audible sound signal is detected that is a song, the toy device may broadcast an audible solicitation to initiate singing. See Block 34. For example, the toy device may broadcast the solicitation, “What's your favorites song? Can you sing it to me?” Alternatively, the toy figure may just start singing a song stored in its memory. After a few bars of singing, the toy character may ask, “Do you know this song? Why don't you sing it with me?” If no singing is detected, the toy figure can start singing another song and again ask for participation. This cycle can repeat until the child starts to sing.

Once a person sings, that person may sing in one of many different musical keys. Alternatively, the person singing may be a bad singer and may begin to sing off-key. Referring to Block 36, it can be seen that the pitch of the incoming sound signal is determined. The ability to determine the pitch of a sound signal is described in U.S. patent application Ser. No. ______, entitled Device And Method For Controlling Electronic Output Signals As A Function Of Received Audible Tones, the disclosure of which is incorporated into this specification by reference.

Once the relative octave range is identified, a single note from the incoming sound signal is identified. See Block 38. The note that is first identified is considered to be the basis note, for the purpose of a mathematical analysis. Referring to Block 40, it can be seen that once a basis note is identified, subsequent notes are detected to produce an active song template. The data contained in the active song template does not represent the actual musical notes being detected, as referenced on a musical octave scale. Rather, the active song template contains the difference value of all subsequent notes relative to the basis note. For example, the first verse of the song “Twinkle, Twinkle, Little Star” has the musical notes C-C-G-G-A-A-G. If the first detected note is “C”, this note is taken as the basis note. The basis note is considered a zero (0) for the purpose of creating the active song template. The subsequent notes are assigned numerical values corresponding to the number of notes that above or below the basis note. The note sequence of Twinkle, Twinkle, Little Star, C-C-G-G-A-A-G, therefore converts to the active song template 0-0-7-7-9-9-7. The active song template 0-0-7-7-9-9-7 occurs because the first note “C” is the basis note and is given the value zero (0). The second note is also a “C”. Thus, it is also given the value zero (0). The third and fourth notes are both “G's” which are seven (7) notes above the basis note “C”. The fifth and sixth notes are “A's” which are nine notes above the basis note “C”. Since the first note is the basis note and is always given the value zero (0), the first zero can be ignored for numeric processing.

The numeric active, song template that is created therefore depends upon the change in notes, rather than the notes themselves. If a person sings flat, that person usually sings all the notes flat. The song may be poorly sung, but the change in notes would be generally the same as those of a well-sung song. The numeric active song template therefore remains fairly constant for a song, regardless of whether the song is sung by a person with singing talent or without singing talent.

Once a numeric song template is created, that active song template is compared to a library of song templates for various songs. See Block 42. If the active song template matches a stored song template within some predetermined margin of error (i.e. over 75%), then an adequate match is found. See Block 44. If an adequate match cannot be found, the system continues to select basis notes and both create and compare new active song templates.

If an active song template is found to match a stored song template, the song associated with that stored song template is retrieved from memory. See Block 46. The song is then broadcast through the speaker 14 (FIG. 1) of the toy figure. See Block 48.

The song can be broadcast from its beginning. However, it is preferred that the song be broadcast from a point close to where the person is singing. Thus, if a person is singing a song, the toy figure can recognize the song and begin to sing along with the person singing.

The toy figure therefore has the appearance of listening to a person sing, recognizing the song and singing along with the person singing.

From the above description, it will be understood that the present invention system can be embodied in many ways. It can be embodied in a toy, a mirror, a box or most any other object. A toy figure is preferred because of the interactive nature of the system. Play value is enhanced by providing a figure that is interactive rather than an inanimate object, such as a ball.

It will be understood that the embodiment of the present invention that is illustrated and described is merely exemplary and that a person skilled in the art can make many variations to that embodiment using functionally equivalent components. All such variations, modifications and alternate embodiments are intended to be included within the scope of the present invention as defined by the claims.

What is claimed is:

1. A method of retrieving a musical recording from a database, comprising the steps of:
providing a database containing a plurality of musical recordings, wherein each of said plurality of musical recordings has a musical tune, and wherein each of said plurality of musical recordings is identified by a numerical code derived from said tune;
detecting an audible musical tune;
deriving a numerical code for said audible musical tune;
comparing the numerical code for said audible musical tune with the numerical code of each of said plurality of musical recordings until at least a partial match is found; and
retrieving a selected musical recording from said plurality of musical recordings that has a numerical code found to at least partially match the numerical code of said audible musical tune.

2. The method according to claim 1, further including the step of audibly broadcasting said selected musical recording.

3. The method according to claim 2, further including the step of synchronizing said selected musical recording with said audible musical tune prior to broadcasting said selected musical recording.

4. The method according to claim 1, wherein said step of deriving a numerical code for said audible musical tune includes the substeps of:
identifying one note contained within said audible musical tune;
assigning a numerical value to said one note;
identifying subsequent notes contained within said audible musical tune; and
assigning subsequent numerical values to said subsequent notes.

5. The method according to claim 4, wherein said substep of assigning subsequent numerical values includes comparing subsequent notes to said one note to determine differences in degree, and assigning numerical numbers depending upon said differences in degree.

6. A method of operation for a novelty device, said method comprising the steps of:
detecting an audible musical tune;
identifying said audible musical tune by comparing said audible musical tune to known musical tunes; and
broadcasting a known musical tune that matches said audible musical tune.

7. The method according to claim 6, wherein said step of detecting an audible musical tune includes receiving said audible musical tune through a microphone and converting said audible musical tune into a digital signal.

8. The method according to claim 6, wherein said step of identifying said audible musical tune by comparing said audible musical tune to known musical tunes includes converting said audible musical tune into a numerical sequence and comparing said numerical sequence to numerical sequences that correspond to said known musical tunes.

9. The method according to claim 6, further including the step of synchronizing said known musical tune with said audible musical tune prior to broadcasting said known musical tune.

10. The method according to claim 8, wherein said step of converting said audible musical tune into a numerical sequence includes the substeps of:
identifying one note contained within said audible musical tune;
assigning a numerical value to said one note;
identifying subsequent notes contained within said audible musical tune; and
assigning subsequent numerical values to said subsequent notes.

11. The method according to claim 10, wherein said substep of assigning subsequent numerical values includes comparing subsequent notes to said one note to determine differences in degree, and assigning numerical numbers depending upon said differences in degree.

12. The method according to claim 11, further including the step of audibly prompting a person to sing an audible musical tune.

13. The method according to claim 12, wherein said step of audibly prompting a person to sing an audible musical tune includes randomly singing a known musical tune and audibly broadcasting an invitation to sing along.

14. A system for recognizing an audible musical tune, comprising:
a microphone for receiving note sequences contained within an audible musical tune;
a memory containing note sequences from known songs;
a microprocessor coupled to said memory that receives said note sequences contained within said audible musical tune and compares them to said note sequences from said known songs in search of a match;
a speaker for broadcasting a known song found to match said audible musical tune.

15. The system according to claim 14, wherein said microphone, said microprocessor, said memory and said speaker are configured within a toy character.
